(19) United States
(12) Patent Application Publication
(10) Pub. No.: US 2024/0094096 A1
(43) Pub. Date: Mar. 21, 2024

(54) STACKABLE ENVIRONMENTAL AIR SAMPLING PUMP

(71) Applicant: IDEAL Industries, Inc., Sycamore, IL (US)

(72) Inventors: Brandon Trainer, Bedfordshire (GB); Aamir Qureshi, Cambridgeshire (GB); Andy Mitham, Hertfordshire (GB)

(21) Appl. No.: 18/258,137

(22) PCT Filed: Dec. 17, 2020
(86) PCT No.: PCT/US2020/065622

§ 371 Date: Jun. 16, 2023

(51) Int. Cl. G01N 1/22

(52) U.S. Cl. CPC G01N 1/2273

(57) ABSTRACT

A stackable environmental air sampling pump includes an external housing, an air pump inside the external housing, and a telescopic mast attached to the housing and configured to extend from the external housing. The external housing includes a recessed portion configured to receive a flexible tubing wrapped around the recessed portion and a handle on a first side of the external housing. The external housing further includes a first interlocking feature of a first type on a second side of the external housing, wherein the first interlocking feature is configured to connect to an interlocking feature of a second type. The external housing further includes a second interlocking feature of the second type on a third side of the external housing, wherein the second interlocking feature is configured to connect to an interlocking feature of the first type.

### FIELD OF THE DISCLOSURE

The present disclosure relates generally to environmental air sampling pumps and more particularly to environmental air sampling pumps that are stackable.

### BACKGROUND OF RELATED ART

There are numerous types and styles of air pumps which may be used by environmental professionals for collecting air samples to test for environmental hazards present in air. For example, such air pumps may be used in testing for asbestos present in a building.

However, it is seen that the deployment of such devices may be difficult, as it may be desirable to use multiple air pumps simultaneously when performing environmental air sampling at a given site. In such examples, an environmental professional may have to carry or otherwise transport multiple air pumps by hand to a site, which may be difficult and/or time consuming depending on the number of air pumps desired.

There remains an identifiable need to provide an improved air pump for various applications, such as for uses where multiple air pumps may be desirable.

### SUMMARY

Described herein are stackable environmental air sampling pumps and methods for using them, as well as mushroom valves that may be built into an external housing of the stackable environmental air sampling pumps to release air from inside the external housing of the air pump to outside the external housing of the air pump.

A better appreciation of the objects, advantages, features, properties, and relationships of the subject matter disclosed herein will be obtained from the following detailed description and accompanying drawings which set forth illustrative examples which are indicative of the various ways in which the principles of the described embodiments may be employed.

### BRIEF DESCRIPTION OF THE DRAWINGS

FIG. 1 is a perspective view of multiple air pumps deployed in accordance with the teachings of the present disclosure.

FIG. 2 is a rear elevational view of a first example stackable environmental air sampling pump in accordance with the teachings of the present disclosure.

FIG. 3 is a perspective view of the first example stackable environmental air sampling pump of FIG. 2 in accordance with the teachings of the present disclosure.

FIG. 4A is a front elevational view of the first example stackable environmental air sampling pump of FIG. 2 in accordance with the teachings of the present disclosure.

FIG. 4B is a right side elevational view of the first example stackable environmental air sampling pump of FIG. 2 in accordance with the teachings of the present disclosure.

FIG. 4C is a left side elevational view of the first example stackable environmental air sampling pump of FIG. 2 in accordance with the teachings of the present disclosure.

FIG. 4D is a top plan view of the first example stackable environmental air sampling pump of FIG. 2 in accordance with the teachings of the present disclosure.

FIG. 4E is a bottom plan view of the first example stackable environmental air sampling pump of FIG. 2 in accordance with the teachings of the present disclosure.

FIG. 4F is an isometric perspective view of the first example stackable environmental air sampling pump of FIG. 2 in accordance with the teachings of the present disclosure.

FIG. 4G is a bottom rear perspective view of the first example stackable environmental air sampling pump of FIG. 2 in accordance with the teachings of the present disclosure.

FIG. 5 is a perspective view of two stackable environmental air sampling pumps stacked together in accordance with the teachings of the present disclosure.

FIG. 6 is another perspective view of two stackable environmental air sampling pumps of FIG. 5 in accordance with the teachings of the present disclosure.

FIGS. 7 and 8 are perspective views of three stackable environmental air sampling pumps stacked together in accordance with the teachings of the present disclosure.

FIGS. 9A and 9B are perspective views of a second example stackable environmental air sampling pump in accordance with the teachings of the present disclosure.

FIGS. 10A-10D are perspective views of a third example stackable environmental air sampling pump in accordance with the teachings of the present disclosure.

FIGS. 11A and 11B are perspective views of a fourth example stackable environmental air sampling pump in accordance with the teachings of the present disclosure.

FIG. 12 is a perspective view of two stackable environmental air sampling pumps partially stacked together in accordance with the teachings of the present disclosure.

FIG. 13A is a partial, rear elevational view of the first example stackable environmental air sampling pump of FIG. 2 in accordance with the teachings of the present disclosure.

FIG. 13B is a partial, cross-sectional rear view of the first example stackable environmental air sampling pump of FIG. 2 taken along cross-sectional cut line A in FIG. 4E in accordance with the teachings of the present disclosure.

FIG. 13C is a partial, cross-sectional rear view of the first example stackable environmental air sampling pump of FIG. 2 taken along cross-sectional cut line B in FIG. 4E in accordance with the teachings of the present disclosure.

FIG. 14A is a partial, cross-sectional perspective view of the first example stackable environmental air sampling pump of FIG. 2 taken along cross-sectional cut line C of FIG. 13A in accordance with the teachings of the present disclosure.

FIG. 14B is a partial, cross-sectional perspective view of the first example stackable environmental air sampling pump of FIG. 2 taken along cross-sectional cut line D of FIG. 13A in accordance with the teachings of the present disclosure.

FIG. 14C is a partial, cross-sectional perspective view of the first example stackable environmental air sampling pump of FIG. 2 taken along cross-sectional cut line E of FIG. 13A in accordance with the teachings of the present disclosure.

FIG. 15 is a perspective view of a mushroom valve in accordance with the teachings of the present disclosure.

FIG. 16 is a partial, perspective view of an air inlet cutout of an example stackable environmental air sampling pump in accordance with the teachings of the present disclosure.

FIG. 17 is a partial, front elevational view of an example stackable environmental air sampling pump with a front cover of an external housing removed in accordance with the teachings of the present disclosure.

FIG. 18 is a partial, left side cross-sectional perspective view of the example stackable environmental air sampling pump of FIG. 17 with the front cover of the external housing removed in accordance with the teachings of the present disclosure.

### DETAILED DESCRIPTION

The following disclosure of example methods and apparatus is not intended to limit the scope of the detailed description to the precise form or forms detailed herein. Instead the following disclosure is intended to be illustrative so that others may follow its teachings.

Disclosed herein are various examples of stackable environmental air sampling pumps that may be secured to one another and carried together for transporting the stackable environmental air sampling pumps from one location to another. The stackable environmental air sampling pumps therefore advantageously are easier to use and deploy than prior air pumps that are carried individually and could not stack or otherwise fasten to one another. The stackable environmental air sampling pumps may be easily connected and disconnected from one another by hand, so that the stackable environmental air sampling pumps may be easily separable for deploying the pumps and may be easily reconnected for transport after a deployment of the pumps is complete.

In addition, the stackable environmental air sampling pumps described herein provide additional advantages as further disclosed herein. For example, an external housing of the stackable environmental air sampling pumps may have one or more valves (e.g., mushroom valves) that permit air to move from inside the external housing to outside the external housing, but not vice versa. The mushroom valves may be configured and located such that the external housing of the air pump is substantially waterproof. It is important for environmental air sampling pumps to be substantially waterproof, as they must be frequently washed to keep them clear of any contaminants, dirt, or other harmful materials. Advantageously, the configuration of the one or more mushroom valves allows air moved by the air pump to be directed toward a motor operating the pump inside the external housing. Such air may cool the motor, allowing the pump and motor to move more air without overheating. Air may then escape out of the mushroom valves without compromising the external housing or its waterproof qualities.

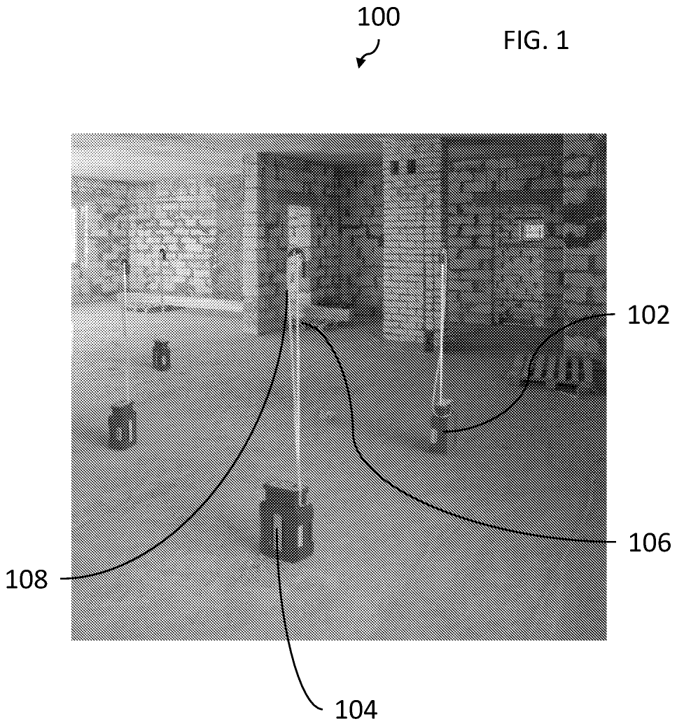

FIG. 1 is a perspective view of multiple air pumps 102 and 104 deployed in accordance with the teachings of the present disclosure. As shown in FIG. 1, a site may be large enough that sampling from multiple locations within a building are required. Accordingly, users may move a single pump around to the different locations, which may take a long time, or multiple pumps may be used.

When deployed, the air pump 104 has an extended mast 106 with tubing 108 attached to the mast 106. A pump inside an external housing of the air pump 104 pulls in air through the tubing 108 so that the air within the building may be sampled.

The use of multiple air pumps as shown in FIG. 1 may be inconvenient for users. For example, a user may have to make multiple trips between a work vehicle and the building to retrieve enough pumps for deployment. The stackable environmental air sampling pumps disclosed herein improve this task for users, as the stackable environmental air sampling pumps may be connected and stacked to one another so that multiple pumps may be carried in each hand by a user.

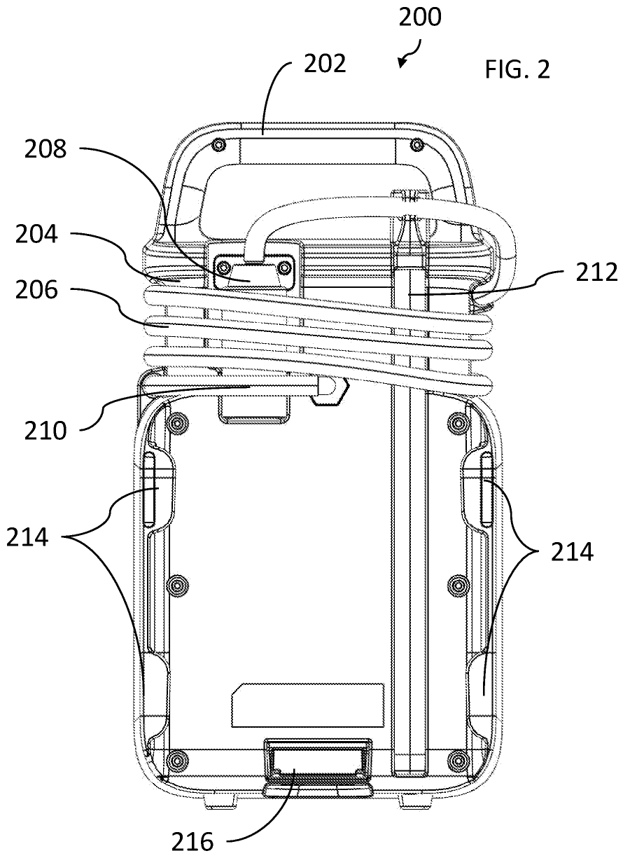

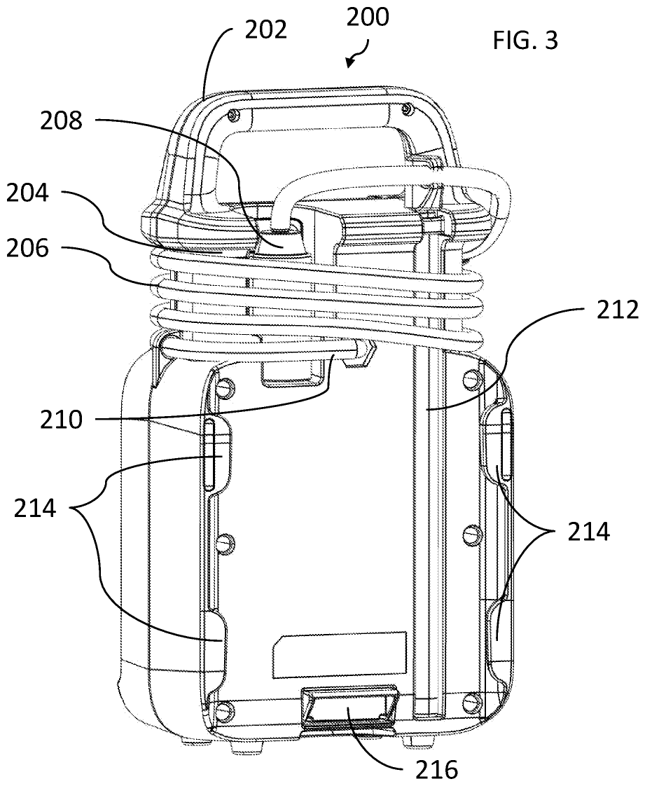

FIG. 2 is a rear elevational view of a first example stackable environmental air sampling pump 200 in accordance with the teachings of the present disclosure. FIG. 3 is another perspective view of the first example stackable environmental air sampling pump 200 of FIG. 2 in accordance with the teachings of the present disclosure. The air pump 200 includes a handle 202 for gripping by a user, and a recess 204 for storing tubing 206 when the air pump 200 is not deployed. A sampling end of the tubing 206 attaches to an air inlet sampling head 208 where air is pulled from the environment at a top of a telescopic mast 212 during deployment. An opposite end of the tubing is connected to an external housing air inlet 210 where the air enters the external housing of the air pump 200.

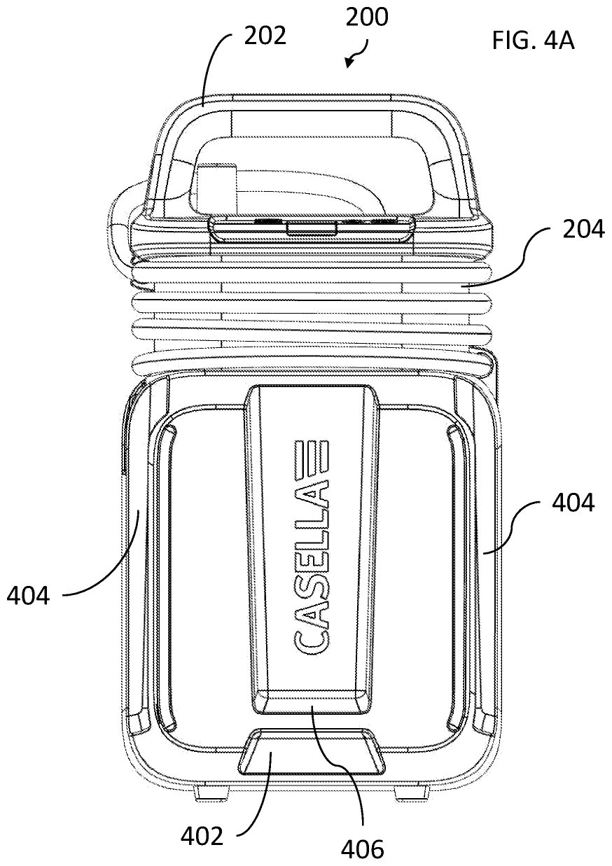

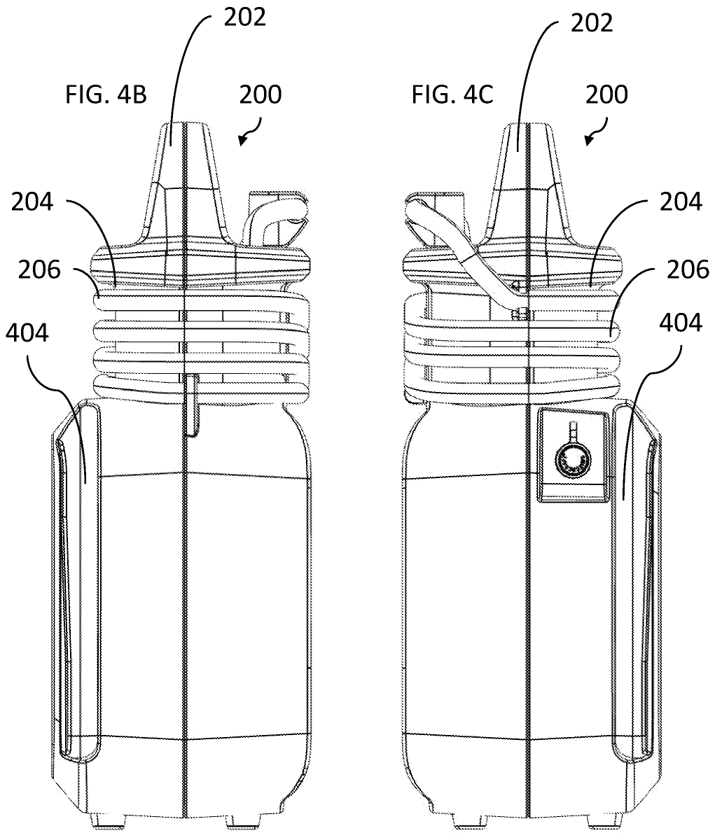

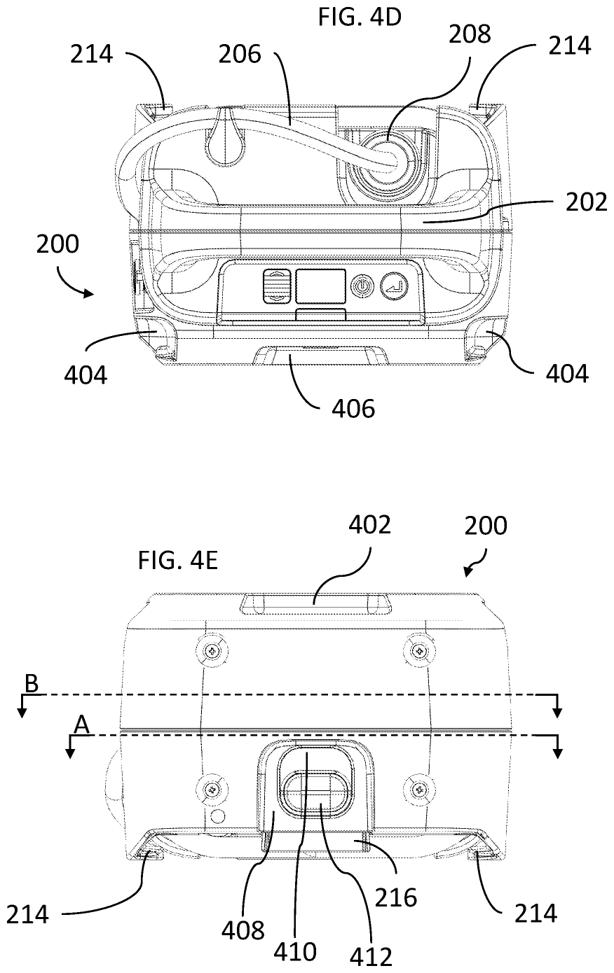

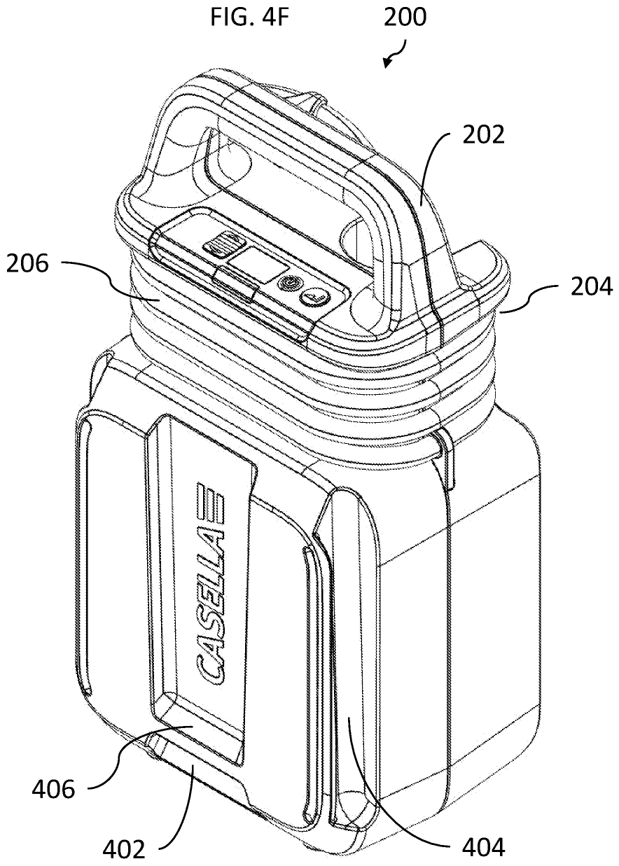

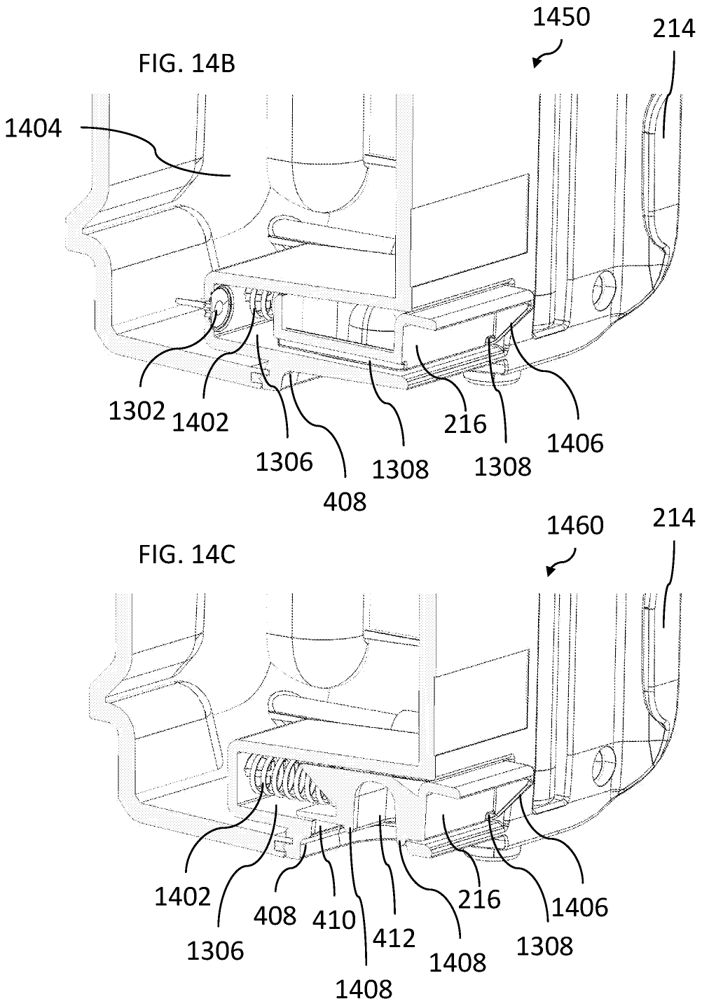

The external housing of the air pump 200 includes interlocking features that allow it to connect to and stack with other air pumps. In particular, a first type of interlocking features in FIG. 2 include feet 214 that slide into a second type of interlocking feature (e.g., grooves as shown in FIGS. 4A-4D and 4F). A third type of interlocking feature is also shown in FIG. 2, which is a latch clip 216. The latch clip 216 is biased outward from the air pump 200 by a spring (shown in and described further with respect to FIGS. 14A-14C). The latch clip 216, as further disclosed herein, may therefore be slotted into an opening of another air pump to releasably attach the air pump 200 to another air pump.

FIG. 4A is a front elevational view of the first example stackable environmental air sampling pump of FIG. 2 in accordance with the teachings of the present disclosure. In FIG. 4A, a second type of interlocking feature, grooves 404, are visible. As described above, the grooves 404 may accommodate an interlocking feature such as the feet 214 shown in FIGS. 2 and 3. A fourth interlocking feature, an opening 402, is also shown in FIG. 4A. The opening 402 is located on a front face of the air pump 200 and is configured to releasably lock into place a latch clip, such as the latch clip 216 shown in FIGS. 2 and 3. A ramp 406 biases such a latch clip inward while air pumps are being stacked, and then the latch clip locks into place into the opening 402 when the air pumps are fully stacked or otherwise aligned. A user may then push the latch clip 216 in by hand to release the latch clip 216 and unstack the air pumps. The operation of pushing in the latch clip 216 to release and unstack the air pumps is described in further detail below with respect to FIGS. 4E, 4G, and 14A-14C.

FIG. 4B is a right side elevational view of the first example stackable environmental air sampling pump of FIG. 2 in accordance with the teachings of the present disclosure. FIG. 4C is a left side elevational view of the first example stackable environmental air sampling pump of FIG. 2 in accordance with the teachings of the present disclosure. As shown in FIGS. 4B and 4C, the grooves 404 are accessible and visible from the side of the air pump 200. In this way, the feet 214 are able to slide into the grooves 404 as disclosed herein. The grooves 404 do not extend all the way to the bottom of the external housing of the air pump 200 as shown in FIGS. 4C and 4D. In this way, the feet 214 may interlock with the grooves 404, but the base of the grooves 404 will interfere with the feet 214 to cause two stacked air pumps to generally align with on another in their stacked positions. In addition, as shown in FIGS. 4B and 4C, the portion of the air pump that includes the recess 204 for storing the tubing 206 is set back away from the grooves 404, so that the feet of another air pump can easy access and slide into the grooves 404 of the air pump 200 without damaging the tubing 206.

FIG. 4D is a top plan view of the first example stackable environmental air sampling pump of FIG. 2 in accordance with the teachings of the present disclosure. As discussed above and further shown in FIG. 4D, the grooves 404 are accessible from a top of the air pump 200, but have a portion toward the bottom of the air pump 200 that interfere with feet (e.g., the feet 214) of another air pump so that the air pumps generally align when stacked. Also visible in FIG. 4D is the ramp 406 that is configured to bias a latch clip (e.g., the latch clip 216) of another air pump, so that air pumps may be locked into place with respect to one another (e.g., so that the feet of another air pump cannot move up within the grooves 404 while the latch clip of another air pump is in a locked position past the ramp 406). Thus, a combination of the interlocking features disclosed herein (e.g., the feet 214, the grooves 404, the latch clip 216, the ramp 406, and the opening 402) may be used to releasably lock multiple air pumps to one another. These interlocking features represent merely one example of how air pumps may be stacked to one another, secured to one another, or locked to one another. Any other types or configurations of interlocking features may also be used in various embodiments.

FIG. 4E is a bottom plan view of the first example stackable environmental air sampling pump of FIG. 2 in accordance with the teachings of the present disclosure. FIG. 4F is an isometric perspective view of the first example stackable environmental air sampling pump of FIG. 2 in accordance with the teachings of the present disclosure. FIG. 4G is a bottom rear perspective view of the first example stackable environmental air sampling pump of FIG. 2 in accordance with the teachings of the present disclosure. FIG. 4E shows that the bottom of the external housing of the air pump 200 includes a recess 408 and an opening 410 within the recess 408, both of which are also visible in FIGS. 4G and 14C). The opening within the recess 408 reveals a portion of the latch clip 216 that is configured to move within a slot in the external housing of the air pump 200 as disclosed herein. In particular, the latch clip 216 may normally be biased in a position as shown in FIG. 4E, but can be pushed against a spring or other biasing member to move in a direction toward a front of the air pump 200. In addition, a handle 412 of the of the latch clip 216 is configured for a user to manually grab the latch clip 216 with their hand to pull the latch clip 216 toward a front of the air pump 200. In this way, the latch clip 216 may be disengaged with another air pump to which the air pump 200 may be locked stacked. As shown in and discussed further below with respect to FIG. 14C, the handle 412 may be configured such that the latch clip 216 moves within the opening 410 and that movement of the latch clip 216 is bounded by interference between the handle 412 and the opening 410.

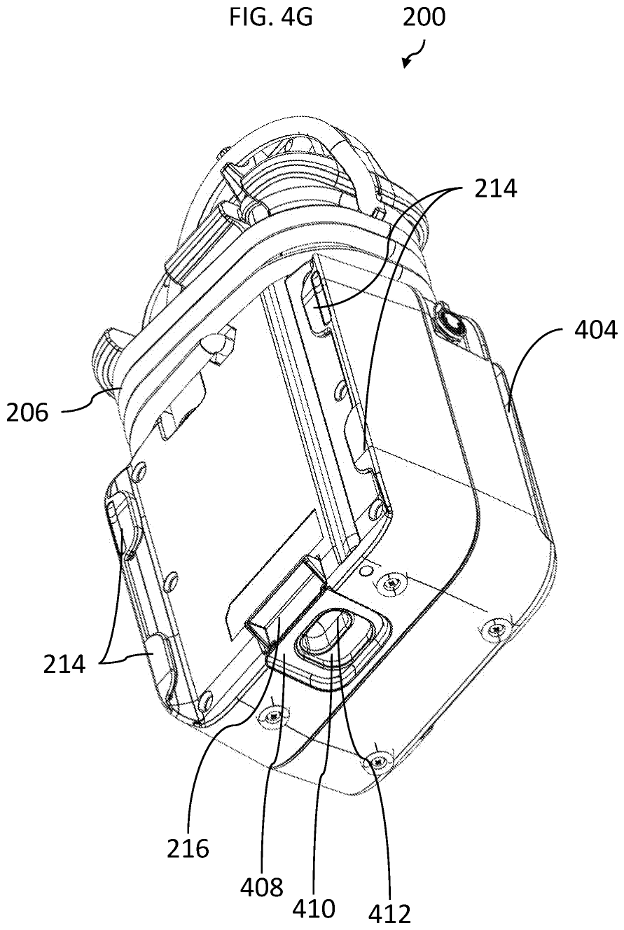

FIG. 5 is a perspective view of two stackable environmental air sampling pumps stacked together in accordance with the teachings of the present disclosure. FIG. 6 is another perspective view of two stackable environmental air sampling pumps of FIG. 5 in accordance with the teachings of the present disclosure. For example, the air pump 200 may be stacked to another air pump 500 according to the embodiments disclosed herein.

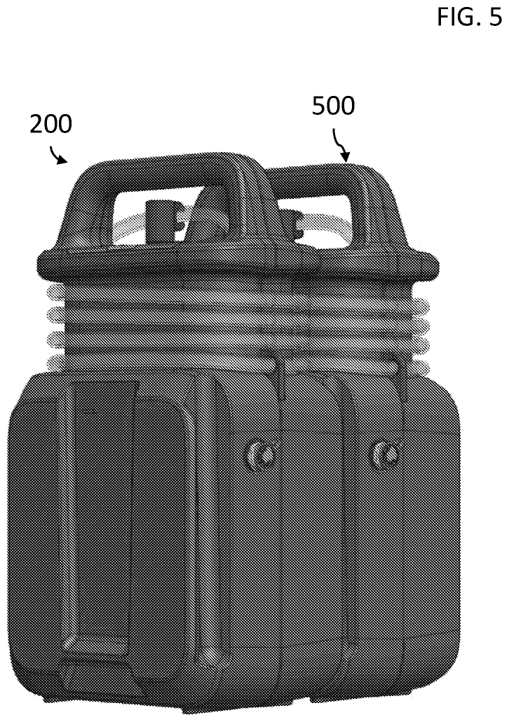

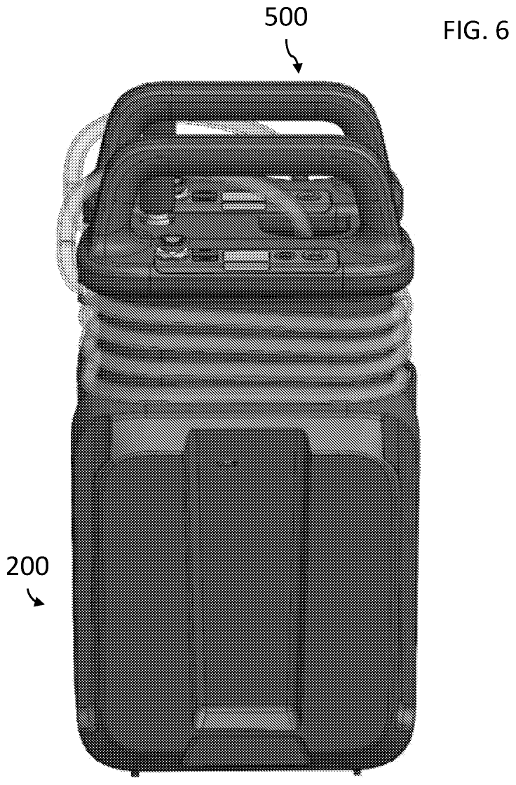

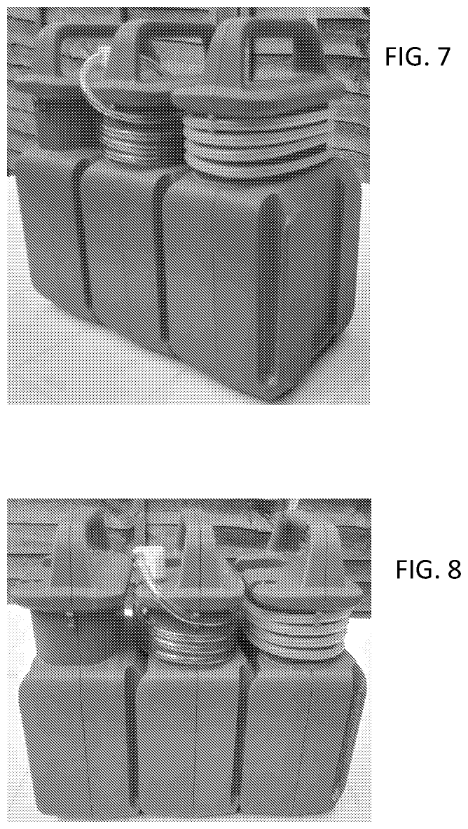

FIGS. 7 and 8 are perspective views of three stackable environmental air sampling pumps stacked together in accordance with the teachings of the present disclosure. Accordingly, three or more air pumps may be stacked together as shown in FIGS. 7 and 8, as each air pump has at least two interlocking features that correspond to one another so that any number of air pumps may be stacked together.

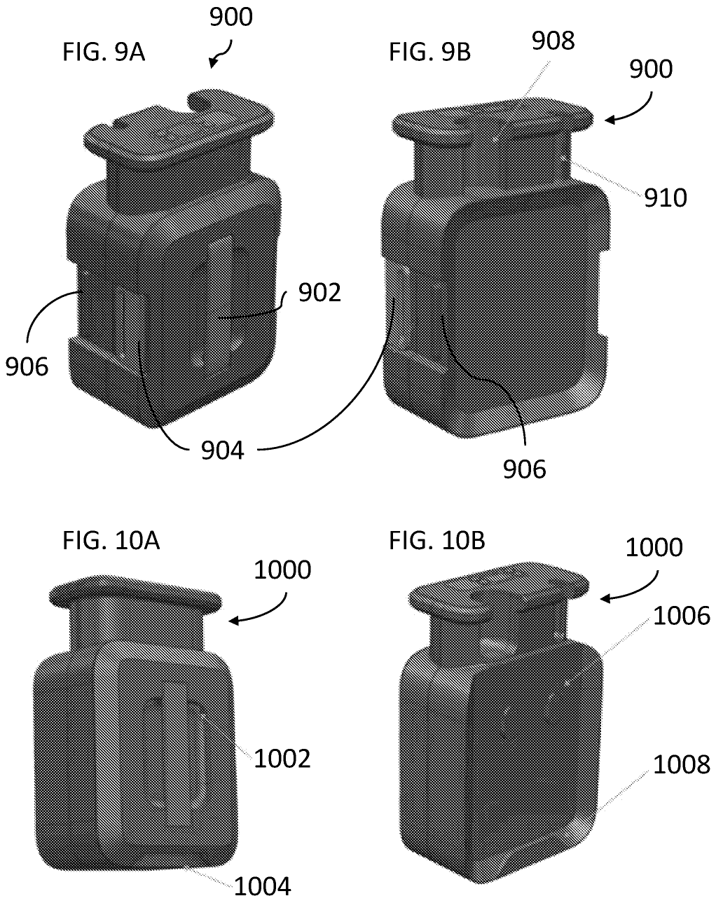

FIGS. 9A and 9B are perspective views of a second example stackable environmental air sampling pump 900 in accordance with the teachings of the present disclosure. In the example of FIGS. 9A and 9B, a clip 904 may be used to fasten one air pump to another. In particular, the clip 904 has an opening that corresponds to a feature 906 on the air pump 900. In this way, the clip 904, which is hinged, may fold to attach to the feature 906 of another air pump (not pictured). In addition, in the example of FIGS. 9A and 9B, a handle 902 of the air pump 900 is located on a front side of the air pump 900 instead of the top of the air pump 200 as shown in FIGS. 2-8. As such, the handle 902 has a flat profile with the rest of the external housing and a cutout in the external housing, so that a user may grasp the handle 902 but the air pump 900 may still be stacked with another air pump. Additionally, the external housing of the air pump 900 includes cutouts 908 and 910 to accommodate tubing and a mast for the air pump, while still allowing the air pump 900 to be stacked with other air pumps. Such cutouts are also present in other examples disclosed herein.

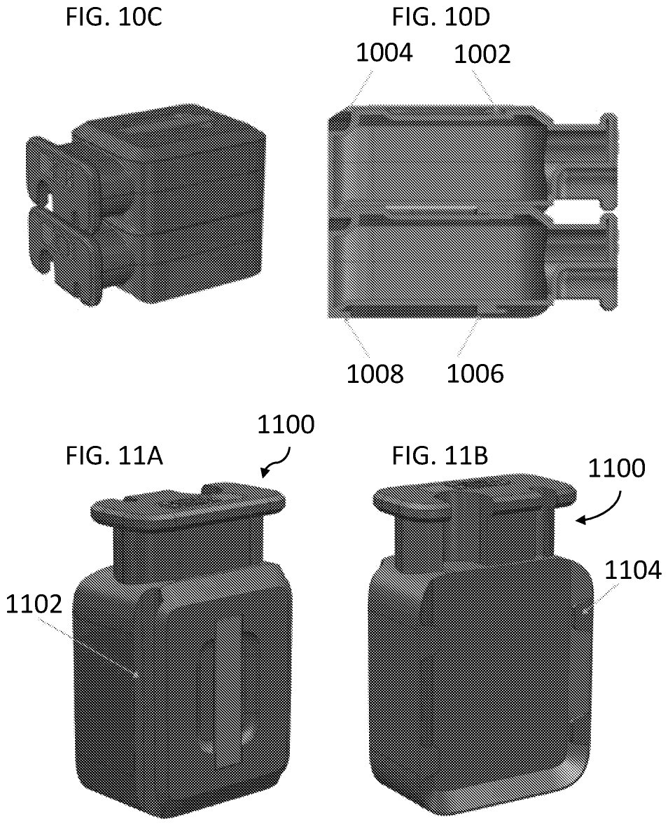

FIGS. 10A-10D are perspective views of a third example stackable environmental air sampling pump 1000 in accordance with the teachings of the present disclosure. The air pump 1000 includes upper hooks 1006 and a lower hook 1008 that may be accommodated by upper grooves 1002 and a lower groove 1004, respectively. FIGS. 10C and 10D show two such air pumps stacked together. In the example of FIGS. 10A-10D, at least one feature for interlocking the air pumps is located on a same side of the external housing of the air pump 900 as the handle of the air pump 900 (namely the upper grooves 1002 and the lower groove 1004).

FIGS. 11A and 11B are perspective views of a fourth example stackable environmental air sampling pump 1100 in accordance with the teachings of the present disclosure. The air pump 1100 includes feet 1104 that fit into grooves 1102, and also has a handle on the front side rather than on top of the air pump 1100.

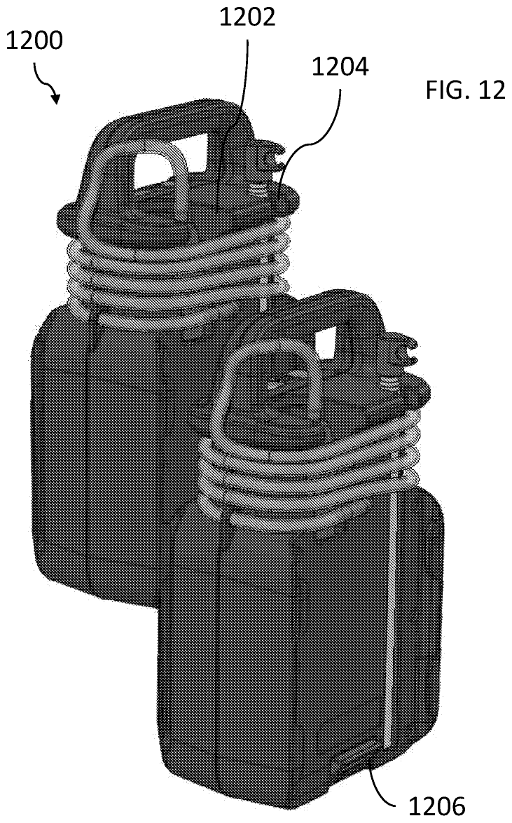

FIG. 12 is a perspective view of two stackable environmental air sampling pumps partially stacked together in accordance with the teachings of the present disclosure. Similar to FIG. 9 above, cutouts 1202 and 1204 are shown which accommodate a mast and tubing for the pump, while still allowing the pumps to be stacked. FIG. 12 also shows a latch clip 1206.

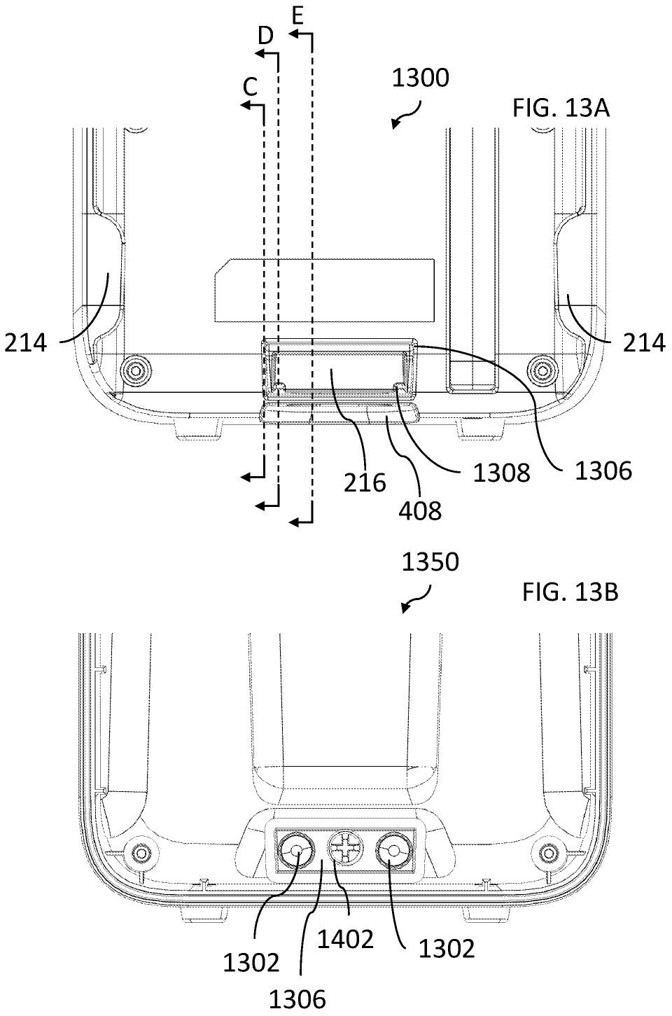

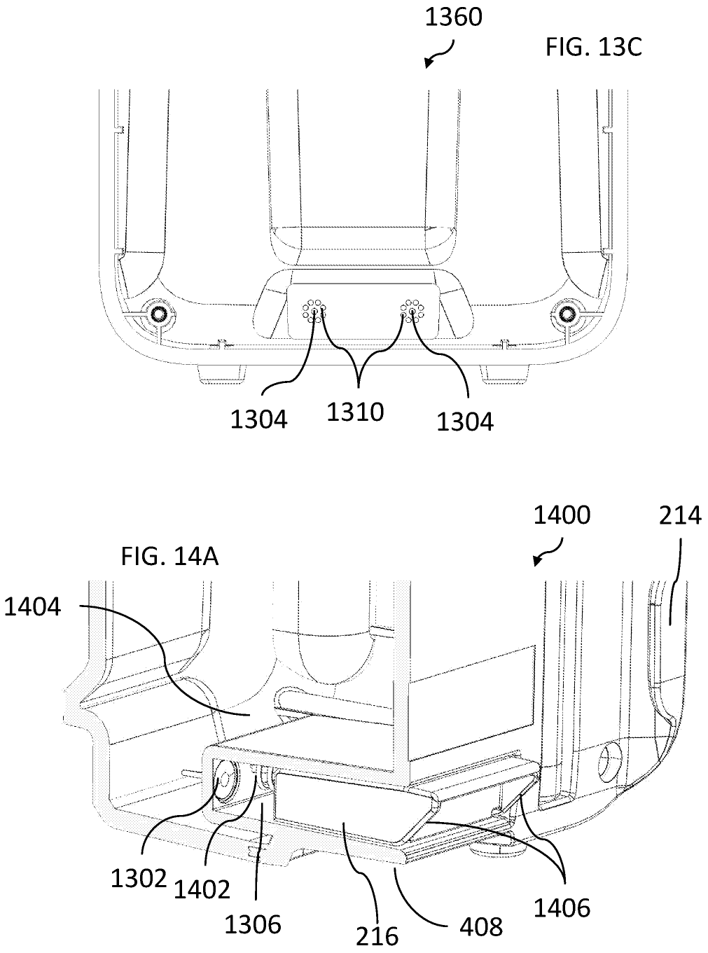

FIG. 13A is a partial, rear elevational view 1300 of the first example stackable environmental air sampling pump of FIG. 2 in accordance with the teachings of the present disclosure. In FIG. 13A, multiple cross-sectional cut lines C, D, and E are shown, which correspond to the views shown in FIGS. 14A, 14B, and 14C, respectively. In particular, in each of FIGS. 13A-13C and 14A-14C, further details of the latch clip 216, an opening 1306 in the external housing of the air pump 200, mushroom valves 1302, and holes 1304 and 1310 within the opening 1306 of the external housing are shown. In FIG. 13A, the mushroom valves 1302 and the holes 1304 and 1310 are hidden behind the latch clip 216. The latch clip 216 fits in an opening 1306 in the external housing of the air pump 200. The latch clip 216 further has air channels 1308 that allow air to pass from behind the latch clip 216 (e.g., inside the opening 1306) to the environment surrounding the external housing of the air pump 200.

FIG. 13B is a partial, cross-sectional rear view 1350 of the first example stackable environmental air sampling pump of FIG. 2 taken along cross-sectional cut line A in FIG. 4E in accordance with the teachings of the present disclosure. Visible in FIG. 13B is the mushroom valves 1302 that are located within the opening 1306. In FIG. 13B, the latch clip 216 is not visible, and heads of the mushroom valves 1302 are shown outside of the external housing of the air pump 1300. In this way, the latch clip 216 hides the mushroom valves 1302 so that they cannot be tampered with, and air can still escape from within the external housing past the mushroom valves 1302 and around the latch clip 216 via the air channels 1308. The latch clip 216 further blocks the mushroom valve 1302 heads to help ensure that the external housing of the air pump 1300 stays substantially waterproof. In other words, while the mushroom valves 1302 are within the opening 1306 and hidden to a user behind the latch clip 216, a head of the mushroom valves 1302 is still outside of the external housing of the air pump 200 and the mushroom valves 1302 may be used to release air from within the external housing to outside of the external housing. A spring 1402 is also shown, which may serve as a biasing member that causes the latch clip 216 to be biased in a position toward the rear of the air pump 200 as disclosed herein.

FIG. 13C is a partial cross-sectional rear view 1360 of the first example stackable environmental air sampling pump of FIG. 2 taken along cross-sectional cut line B in FIG. 4E in accordance with the teachings of the present disclosure. In particular, FIG. 13C shows a surface of the opening 1306 that includes the holes 1304 and 1310. The holes 1310 are configured to fluidly connect an inside of the external housing of the air pump 200 with an outside of the external housing of the air pump 200. In this way air may escape from inside the air pump 200 to an external environment around the air pump 200. The holes 1304 are configured to accommodate a step of the mushroom valves 1302. In this way, the mushroom valves 1302 may sit in the holes 1304 such that the mushroom valves 1302 permit air to move from inside the external housing of the air pump 200 to outside of the external housing, but the mushroom valves 1302 blocks the holes 1310 to prevent fluids (e.g., water, air) from moving from outside the external housing to inside the external housing of the air pump 200.

FIG. 14A is a partial, cross-sectional perspective view 1400 of the first example stackable environmental air sampling pump of FIG. 2 taken along cross-sectional cut line C of FIG. 13A in accordance with the teachings of the present disclosure. As shown in FIG. 14A, the latch clip 216 is outside of the external housing of the air pump 200, as an internal chamber 1404 is created by the external housing of the air pump 200 and forms the opening 1306 that accommodates the latch clip 216. A spring 1402 is also shown in FIG. 14A, which allows the latch clip 216 to be biased outward away from the mushroom valves 1302 as disclosed herein, but may be pushed in when two air pumps are being stacked together or when a user desires to separate stacked air pumps from one another. In other words, the latch clip 216 may move within the opening 1306 based on forces acting upon the latch clip 216 (e.g., force from the spring 1402, force from a user's hand, force from an interlocking feature of another air pump).

As further shown in FIG. 14A, the latch clip 216 includes angled portions 1406 that may interfere with an interlocking feature of an external housing of another air pump (e.g., something similar to the ramp 406 disclosed herein) to push the latch clip 216 toward a front of the air pump 200. In addition, the mushroom valve 1302 includes a head that is within the opening 1306, while a stem of the mushroom valve 1302 is within the internal chamber 1404 of the air pump 200.

FIG. 14B is a partial, cross-sectional perspective view 1450 of the first example stackable environmental air sampling pump of FIG. 2 taken along cross-sectional cut line D of FIG. 13A in accordance with the teachings of the present disclosure. FIG. 14B shows in greater detail one of the air channels 1308 that allow air to pass around the latch clip 216 (e.g., when air is released by the mushroom valves 1302 from the internal chamber 1404 of the air pump 200).

FIG. 14C is a partial, cross-sectional perspective view 1460 of the first example stackable environmental air sampling pump of FIG. 2 taken along cross-sectional cut line E of FIG. 13A in accordance with the teachings of the present disclosure. FIG. 14C demonstrates how the handle 412 is accessible to a user of the air pump 200 to move the latch clip 216. In particular, the handle 412 is accessible to a user via the recess 408 and the opening 410, and the handle 412 is further configured to receive one or more fingers of a user so that the user can push the latch clip 216 toward the front of the air pump 200 (e.g., toward the spring 1402) so that, for example, the latch clip 216 may be released from interlocking features of another air pump that is stacked with the air pump 200.

The latch clip 216 further includes a protrusion 1408 that surrounds the opening for the handle 412. The protrusion 1408 extends into the opening 410 to limit a range of movement of the latch clip 216. In this way, the spring 1402 does not push the latch clip 216 out of the opening 1306 and a user may not push latch clip 216 too far toward a front of the air pump 200. This limited movement may, for example, prevent the latch clip 216 from coming into contact with the mushroom valves 1302. This may be advantageous because the latch clip 216 will therefore not interfere with the functioning of the mushroom valves 1302, and will not damage the mushroom valves 1302.

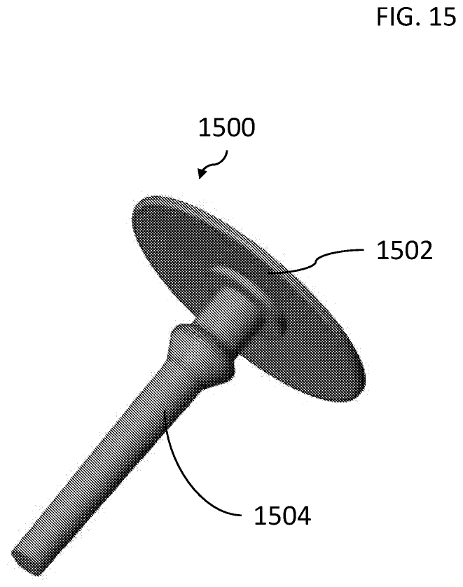

FIG. 15 is a perspective view of a mushroom valve 1500 in accordance with the teachings of the present disclosure. The mushroom valves 1302 disclosed herein may each be similar to the mushroom valve 1500. The mushroom valve 1500 includes a stem 1504 and a head 1502. The head 1502 is the portion of the mushroom valves 1302 visible in FIG. 13B, and both the head and stem of the mushroom valves 1302 are visible in FIGS. 14A and 14B.

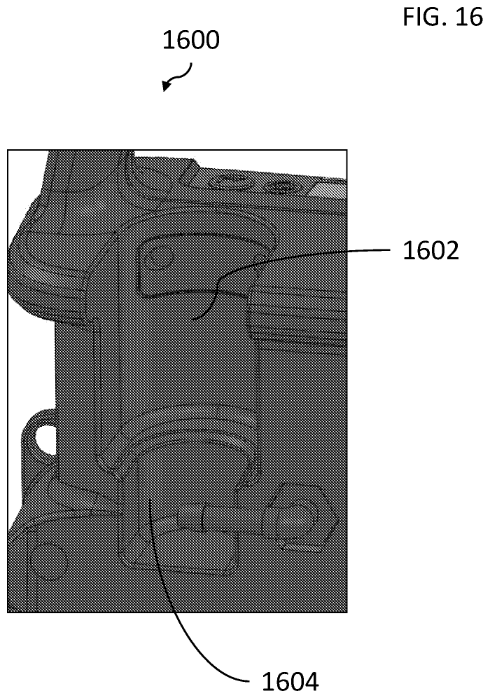

FIG. 16 is a partial, perspective view 1600 of an air inlet cutout of an example stackable environmental air sampling pump in accordance with the teachings of the present disclosure. For example, the air inlet cutout may be the same as or similar to the cutout 1202 shown in FIG. 12, and may be configured to accommodate an air inlet such as the air inlet sampling head 208 shown in FIGS. 2, 3, and 4D. The cutout may include a first portion 1602 and second portion 1604 that are different sizes or widths to accommodate different sized air inlet sampling heads. For example, air inlet sampling heads may come in different sizes such as 25 millimeter (mm) or 37 mm. In such an example, the first and second portions 1602 and 1604 may be sized to snugly and securely fit air inlet sampling heads of different sizes while an air pump is being transported. Advantageously, this allows an air inlet sampling head to be fixed to tubing and secured to an external housing of an air pump for whenever the air pump is not in use. This provides secure and convenient storage for a desired air inlet sampling head on the air pump itself, rather than having to carry or store a sampling head separately, or having the sampling head move around while attached to tubing while transporting the air pump, which could cause damage to the sampling head.

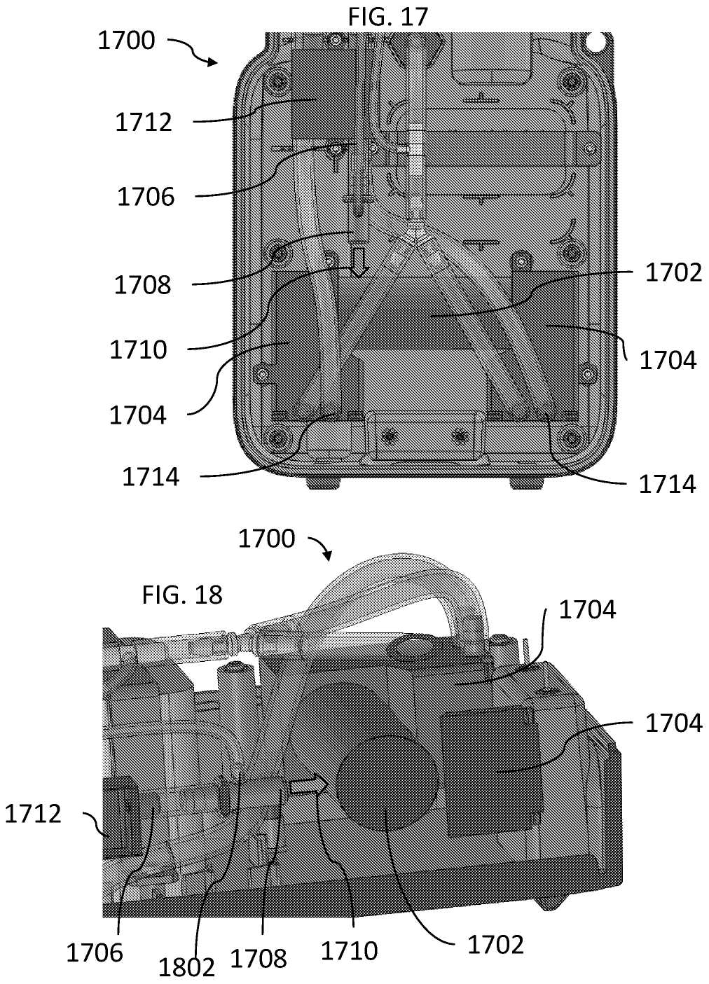

FIG. 17 is a partial, front elevational view of an example stackable environmental air sampling pump 1700 with a front cover of an external housing removed in accordance with the teachings of the present disclosure. FIG. 18 is a partial, left side cross-sectional perspective view of the example stackable environmental air sampling pump 1700 of FIG. 17 with the front cover of the external housing removed in accordance with the teachings of the present disclosure. In other words, FIGS. 17 and 18 show internal components of an air pump that may be inside of an external housing of an air pump as disclosed herein. In particular, FIGS. 17 and 18 show air pumps 1704 that are driven by a motor 1702. The air pumps 1704 have air outlets 1714 that are connected to tubing that fluidly connect the air pumps 1704 to a damper 1712. The damper 1712 has an outlet 1706 that connects to tubing that fluidly connects the damper 1712 to a flow control element 1708. As such, the air output from the air pumps 1714 is ultimately output through the damper 1712 to the flow control element 1708. The flow control element 1708 may be a valve or other type of component that may control any or all of a rate of flow, a direction of flow, or any other aspect of flow of air toward the motor 1702. In this way, as disclosed herein, the motor 1702 may be cooled by the air output from the flow control element 1708.

The flow control element 1708 may be valve or other flow limiting or flow directing device that limits the flow or directs the flow toward the motor 1702. In some embodiments, the flow control element 1708 may also be controllable to adjust the flow direction, rate, or other aspect of flow to varying levels. For example, the flow control element 1708 may be a controllable valve that may be adjusted to direct air onto the motor 1702 at different rates as desired. The flow control element 1708 may also be configured to move or otherwise direct a flow of air (indicated in FIGS. 17 and 18 by an arrow 1710) to different portions of the motor 1702 or even away from the motor 1702. In other words, the flow control element 1708 may be adjustable to change the air flow from the flow control element to be directed in different directions or in other embodiments may be static to always direct air onto the motor 1702 in a particular, desired manner. In examples where the flow control element 1708 is controllable, the flow control element 1708 may further be configured to limit a flow of air directed toward the motor 1702. Tubing 1802 connected to the flow control element 1708 may be connected to a pressure sensor to monitor air pressure in the flow control element 1708. A measurement of air pressure in the flow control element 1708 may be used to adjust aspects of the motor 1702 to get a desired air pressure at the flow control element 1708. In other words, the motor 1702 may be controlled to cause the air pumps 1704 to pump more or less air through the system to get a desired air pressure at the flow control element 1708. In embodiments where the flow control element 1708 is controllable, aspects of the flow control element 1708 may also be adjusted based on a pressure reading of the air in the flow control element to achieve a desired air pressure. Accordingly, the flow control element 1708 may be used to direct known, controllable, and/or continuous flow of air toward the motor 1702, which drives the air pumps 1704 to yield a desired flow, pressure, etc. of air onto the motor 1702.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A stackable environmental air sampling pump comprising:
an external housing;
an air pump inside the external housing; and
a telescopic mast attached to the housing and configured to extend from the external housing,
wherein the external housing comprises:
a recessed portion configured to receive a flexible tubing wrapped around the recessed portion;
a handle on a first side of the external housing;
a first interlocking feature of a first type on a second side of the external housing, wherein the first interlocking feature is configured to connect to an interlocking feature of a second type; and
a second interlocking feature of the second type on a third side of the external housing, wherein the second interlocking feature is configured to connect to an interlocking feature of the first type.

2. The stackable environmental air sampling pump of claim 1, wherein the first interlocking feature of the first type comprises at least one foot and the second interlocking feature of the second type comprises at least one groove.

3. The stackable environmental air sampling pump of claim 1, further comprising a latch clip biased by a spring, wherein:
the latch clip has a fully extended position and at least one recessed position;
the latch clip is biased into the fully extended position unless acted upon by a force to compress the spring;
the latch clip is configured to move into the at least one recessed position while the stackable environmental air sampling pump is in the process of being interlocked with another stackable environmental air sampling pump; and
the latch clip is configured to move into the fully extended position while the stackable environmental air sampling pump is fully interlocked with another air sampling pump.

4. The stackable environmental air sampling pump of claim 1, wherein the external housing further comprises a recess configured to receive a portion of a latch clip of another stackable environmental air sampling pump.

5. The stackable environmental air sampling pump of claim 1, further comprising at least one mushroom valve configured to release air from inside the external housing to an environment outside the external housing.

6. The stackable environmental air sampling pump of claim 5, wherein the at least one mushroom valve is located behind a latch clip configured to lock the stackable environmental air sampling pump to another stackable environmental air sampling pump.

7. The stackable environmental air sampling pump of claim 1, wherein the first side, the second side, and third side are all different sides of the external housing.

8. A stackable environmental air sampling pump comprising:
an external housing; and
an air pump inside the external housing,
wherein the external housing comprises:
a handle on a first side of the external housing;
a first interlocking feature of a first type on a second side of the external housing, wherein the first interlocking feature is configured to connect to an interlocking feature of a second type; and
a second interlocking feature of the second type on a third side of the external housing, wherein the second interlocking feature is configured to connect to an interlocking feature of the first type.

9. The stackable environmental air sampling pump of claim 8, wherein the first side, the second side, and third side are each different sides of the external housing.

10. The stackable environmental air sampling pump of claim 8, wherein the first side and the second side are a same side of the external housing.

11. The stackable environmental air sampling pump of claim 8, wherein the first interlocking feature of the first type comprises at least one foot and the second interlocking feature of the second type comprises at least one groove.

12. The stackable environmental air sampling pump of claim 8, wherein the external housing further comprises a recess configured to receive a portion of a latch clip of another stackable environmental air sampling pump.

13. The stackable environmental air sampling pump of claim 8, further comprising a latch clip configured to releasably lock the stackable environmental air sampling pump to another stackable environmental air sampling pump.

14. The stackable environmental air sampling pump of claim 8, further comprising at least one valve configured to permit air to move from inside the external housing to outside the external housing.

15. The stackable environmental air sampling pump of claim 14, wherein the at least one valve comprises a mushroom valve.

16. The stackable environmental air sampling pump of claim 14, wherein the at least one valve is positioned behind a latch clip attached to the external housing and configured to releasably lock the stackable environmental air sampling pump to another stackable environmental air sampling pump.

17. The stackable environmental air sampling pump of claim 14, wherein the at least one valve is not visible to a user of the stackable environmental air sampling pump.

18. The stackable environmental air sampling pump of claim 8, wherein the external housing comprises an air inlet cutout having a first portion configured to securely stow a first air inlet sampling head of a first size and a second portion configured to securely stow a second air inlet sampling head of a second size different from the first size.

19. An environmental air sampling pump comprising:
an external housing;
an air pump inside the external housing; and
at least one valve configured to permit air to move from inside the external housing to outside the external housing.

20. The environmental air sampling pump of claim 19, wherein the at least one valve comprises a mushroom valve, and further wherein the at least one valve prevents air from moving from the outside of the external housing to the inside of the external housing.

21. The apparatus of claim 19, wherein the at least one valve is not visible to a user of the stackable environmental air sampling pump.

22. The apparatus of claim 19, wherein the environmental air sampling pump further comprises a motor configured to drive the air pump, and further wherein:
the air pump comprises an air inlet and an air outlet;
the air outlet of the air pump is configured to direct air moved by the air pump onto the motor; and
the motor is inside the external housing.

23. The apparatus of claim 22, wherein the environmental air sampling pump further comprises a flow control element fluidly connected to the air outlet of the air pump, wherein the flow control element is configured to control and direct the air moved by the air pump onto the motor.
